(19) United States
(12) Patent Application Publication
(10) Pub. No.: US 2024/0346595 A1
(43) Pub. Date: Oct. 17, 2024

(54) METHOD OF ASSETS ALLOCATION AND SYSTEM THEREOF

(71) Applicant: POW SARL-S, Howald (LU)

(72) Inventors: Pasquale FANIZZA, Howald (LU); Chadia GHELAB, Howald (LU)

(21) Appl. No.: 18/291,533

(22) PCT Filed: Jul. 13, 2022
(86) PCT No.: PCT/EP2022/069665

§ 371 Date: Jan. 23, 2024

(30) Foreign Application Priority Data
Aug. 20, 2021 (LU) LU500565

(51) Int. Cl. G06Q 40/06

(52) U.S. Cl. CPC G06Q 40/06

(57) ABSTRACT

A method and system (1) for determining a weighting (Wi) of a diversified security portfolio, wherein the method comprises: a) receiving, by a first module (M3), a security (S) from an asset database (ROA), said first module, b) upon receipt of the security (S), configuring, by the first module (M3), said diversified security portfolio based on predetermined parameters, said predetermined parameters being transmitted by at least one asset management module (A1, A2, A3, A4; AMT) to the first module (M3), c) determining, by a second module (M7), the weighting (Wi) of the configured diversified security portfolio, said determining being based on current market data parameters (MKT) provided by one or more servers (SRV), said current market data parameters comprising market capitalization of the security, volatility of the security and correlation between securities, and d) transmitting, by a third module (M4), the determined weighting (Wi) to a user interface (INT).

### TECHNICAL FIELD

This disclosure pertains to the field of assets allocation and, more particularly, to a method, a system, a computer software and a computer-readable non-transient recording medium for allocating assets.

### BACKGROUND

Methods and systems are known for managing a portfolio of an investment and, specifically, to maximize its return and minimize its risk. For instance, a portfolio is a collection of financial investments like stocks, bonds, commodities, cash, and cash equivalents, including closed-end funds and exchange traded funds (ETFs) which may provide a return or lead to a loss with corresponding risks. Stocks, bonds, and cash comprise the core of a portfolio. Though this is often the case, it does not need to be the rule. A portfolio may contain a wide range of assets including real estate, art and private investments.

Risks are generally measured with the standard deviation or variance. The standard deviation SD is the measure of the dispersion in a set of data, and it is calculated as square root of the sum of the squared deviations between each observation in the data set and the data set mean, where “xi” is the value of the “ith” point in the set of data, where “<x>” is the mean value of the set of data and where “n” is the number of data points in the set of data.

$$SD = \sqrt{{\sum }_{i = 1}^{n} \frac{{( {x}_{i} - < x > )}^{2}}{n - 1}} \qquad [ Math . 1 ]$$

In particular, the standard deviation SD is generally used to compute the volatility or dispersion of a financial market, i.e. security movements or increases and decreases of financial investments, from its mean within a determined period. Therefore, the standard deviation SD helps to estimate the range in which the market or a security can move. The higher the volatility, the higher the range in which the market or security can potentially move, consequently it is more difficult to predict the direction and the levels that the market or the security can reach. For this reason, markets or securities with high volatility are considered riskier than the ones with lower volatility.

For instance, if the value of the elements of a stock have evolved over five days such that the value on day 1 was +0.5%, the value on day 2 was −1.2%, the value on day 3 was +2.5%, the value on day 4 was −1.6% and the value on day 5 was +0.9%, then the mean of the observations would be equal to 0.22% and the sum of the squared deviations between each observation and the mean of the observations is calculated as follows would be equal to 0.11% and the volatility would be equal to the square root of the latter, namely 3.33%. In other words, these values indicate that the value of the elements of the stock have a probability to increase or decrease by 3.33% within five days.

When wider ranges of time are taken in consideration, the volatility tends to increase and that means that trends and market directions are more unpredictable when forecasts are made over longer periods. However, when considering a portfolio of more securities, the overall volatility depends not only on the volatility of each security but also on the weight of each security in the portfolio and on the correlation between securities.

Herein, financial markets refer broadly to any marketplace where the trading of securities occurs, including the stock market, bond market, forex market, and derivatives market, among others. Financial markets are vital to the smooth operation of the world economy. Herein, volatility is a statistical measure of the dispersion of returns for a given security or market index. In most cases, the higher the volatility, the riskier the security. Volatility is often measured as either the standard deviation or variance between returns from that same security or market index. The correlation between two securities provides a measure of how often these two securities move in the same way, increasing or decreasing.

Herein, the term “security” refers to a fungible, negotiable financial instrument that holds some type of monetary value. It represents an ownership position in a publicly-traded corporation via a stock, a creditor relationship with a governmental body or a corporation represented by owning that entity's bond, or rights to ownership as represented by an option.

The weight of a security in a portfolio represents the percentage of the security in the portfolio. For instance, in a portfolio of two stocks, stock A has a value of 60, stock B has a value of 40. The overall value of the portfolio is (60+40)=100, where stock A has a weight of (60/100)=60% and where stock B has a weight of (40/100)=40%.

Herein, the terms “financial instruments” refers to assets that can be traded, or they can also be seen as packages of capital that may be traded. Most types of financial instruments provide efficient flow and transfer of capital all throughout the world's investors. These assets can be cash, a contractual right to deliver or receive cash or another type of financial instrument, or evidence of one's ownership of an entity. Herein, an asset is a resource with economic value that an individual, corporation, or country owns or controls with the expectation that it will provide a future benefit. When referring to investments, asset also refers to holding.

Herein, the term “asset” is considered equivalent to the term “security asset”, or “security”, a security including all the present and future assets of a given user or owner.

Herein, the term “stock”, or equity, refers to a security that represents the ownership of a fraction of a corporation. This entitles the owner of the stock to a proportion of the corporation's assets and profits equal to how much stock they own. Units of stock are called “shares.”

There are different types of securities and financial instruments and each type of them is affected differently by the economical/financial markets conditions/information. Assets of the same type, like stocks, react differently in the same market conditions

For example, the price of the shares of tech companies may rise as consequence of an economic information, while the price of the shares of companies in the banking sector may fall as consequence of the same information.

Eventually, shares of companies of the same sector may move differently depending on the geographic area where they make the business. Hence, the correlation applied to the financial markets measures how frequently two securities or generally two financial instruments move in the same direction.

The correlation is measured with a coefficient between −1 and +1, where −1 represents the case when the two securities always move in the opposite directions, while +1 represents the case when the two securities always move in the same direction.

It is obvious that correlation helps to better estimate the risk of a portfolio, and a portfolio having securities with low correlation with each other (e.g., stock A and stock B) is able to mitigate its overall risk as there are probabilities that when the price of a stock A falls, the price of stock B rises, so that the gain in stock B fully or partially compensates the loss in stock A.

When calculating the risk or volatility of a portfolio, the correlation is multiplied by the volatility of the individual stocks and that gives the so-called covariance. Covariance measures the directional relationship between the returns on two assets. A positive covariance means that asset returns move together while a negative covariance means they move inversely. Covariance is calculated by multiplying the correlation between the two variables by the standard deviation of each variable.

The formula to calculate the risk of a portfolio of two stocks (stock A and stock B), namely the portfolio standard deviation “PSD”, where “w1” is the portfolio weight of stock A, where “w2” is the portfolio weight of stock B, where “σ1” is the standard deviation of stock A, where “σ2” is the standard deviation of stock B and where “Cov1,2” is the covariance of stock A and stock B which can be expressed as the product “p(1,2)·σ1·σ2”, where “p(1,2)” is the correlation coefficient between stock A and stock B, is as follows:

$$P S D = \sqrt{{w}_{1}^{2} {σ}_{1}^{2} + {w}_{2}^{2} {σ}_{2}^{2} + 2 {w}_{1} {w}_{2} {Cov}_{1 , 2}} \qquad [ Math \text{.2} ]$$

For instance, if the weight of stock A is 60%, if the weight of stock B is 40%, if the volatility of stock A is 15%, if the volatility of stock B is 25% and if the correlation coefficient between stock A and stock B is equal to 0.5, then the volatility or standard deviation of the portfolio can be computed as 16.46%. This means that the portfolio, here only having two stocks, has a volatility just slightly higher than the volatility of stock

A, while is largely lower than the volatility of stock B. Therefore, a strategy based on a diversified portfolio allows to mitigate the risks associated to the investment in each individual security of the same portfolio.

A further element that effects the risks associated to the investments in financial markets is the market capitalisation. Herein, the term “market capitalisation” or market cap refers to the overall market value of a company obtained by multiplying the market shares price by the number of circulating shares on the financial markets. It is well known that the share price of companies with larger market value (size) is less effected by the market fluctuations in comparison with the share price of companies operating in the same geographic area and sector but with smaller size, due to their nature of being well-known, established and therefore considered more reliable. For this reason, portfolios with more exposure to larger market cap companies tend to have less volatility than portfolios investing more in mid or small market cap companies.

Herein, the term “diversification” refers to a risk management strategy that mixes a wide variety of investments within a portfolio. A diversified portfolio contains a mix of distinct asset types and investment vehicles in an attempt at limiting exposure to any single asset or risk. The rationale behind this technique is that a portfolio constructed of different kinds of assets will, on average, yield higher long-term returns and lower the risk of any individual holding or security.

It is known that a strategy based on a diversified portfolio also requires a regular monitoring and rebalancing of the assets. Rebalancing is the process of realigning the weightings of a portfolio of assets. Rebalancing involves periodically buying or selling assets in a portfolio to maintain an original or desired level of asset allocation or risk. In other words, rebalancing is a process in which the portfolio composition is adjusted to keep the risk under control when pursuing a given investment strategy.

For instance, taking the same portfolios of stock A and stock B as above, assuming that the price of stock B has increased by 50% and now has a value of 60 while price of stock A has remained the same, the new portfolio overall value is equal to 60+60=120 and the weight of stock A and stock B is now 50% for each (60/120=50%). Further assuming that correlation and volatilities have not changed, the new portfolio volatility can be computed as being equal to 17.50%. Therefore, because the weight of the stock with higher volatility has increased, the overall portfolio volatility has increased as well.

However, assuming that correlation and volatilities have not changed is not realistic. When considering two stocks, one of them moving in one or the other direction, and the other one staying on the same price level, it is mathematically impossible that the correlation between these two stocks has not changed. It is also not possible that the volatility of the two stocks does not change, unless the moving stock keeps moving like the mean of its movements, and the price of stock remaining at the same level has never changed.

With a rebalancing of the stocks, the weight of stock A and stock B can be brought back to the previous level by selling part of the shares of stock B or by purchasing further shares of stock A. As shown in Table 1 below, this can be obtained by selling the equivalent number of units of stock B representing a value of 20 so that the weights of stock A and of stock B become respectively 60% and 40% or by purchasing the equivalent number of units of stock A representing a value of 30 so that the weights of stock A and of stock B become respectively 60% and 40%.

TABLE 1

| | | | | Stock A | Stock B |
|---|---|---|---|---|---|
| | Stock A | Stock B | Portfolio | weight | weight |
| Before | 60 | 60 | 120 | 50% | 50% |
| rebalancing | | | | | |
| Selling step | 60 | 60 − 20 = 40 | 60 + 40 = 100 | 60/100 = 60% | 40/100 = 40% |
| Purchasing | 60 + 30 = 90 | 60 | 90 + 60 = 150 | 90/150 = 60% | 60/150 = 40% |
| step | | | | | |

With the rebalancing, the portfolio composition is therefore adjusted to maintain the desired level of risk. The rebalancing is generally done quarterly, on semi-annual basis or yearly. A well-diversified portfolio is therefore known as the best way to pursue a long-term secured wealth growth.

investments are not only limited to financial instruments, but also include real estate, equity participations in private companies (private equities), private debts, etc. However, it is obvious that financial instruments are the most accessible type of investments as they are more liquid, transactions as well as the transfer of the holdings is almost instantaneous and do not require in many cases large capitals. A well-diversified portfolio can include financial instruments as well as real estates, private equities, and private debts, however a diversified portfolio only made up with financial instruments is a valid alternative to pursue a wealth growth for those who do not have large capitals to invest in private equities and/or real estates.

Herein, “Private equity” is an alternative investment class and consists of capital that is not listed on a public exchange”. The term “private debt” is typically applied to debt investments which are not financed by banks and are not issued or traded in an open market, while the word “private” refers to the investment instrument itself and not necessarily the borrower—i.e., public companies can borrow via private debt just as private companies can. Private debt falls into a broader category termed “alternative debt” or “alternative credit”, and is used interchangeably with “direct lending”, “private lending” and “private credit”.

Different methods are known for investing in a diversified portfolio of financial instruments. Examples are through a broker or investment funds.

For instance, a broker is an individual or firm that acts as an intermediary between an investor and a securities exchange. Because securities exchanges only accept orders from individuals or firms who are members of that exchange, individual traders and investors need the services of exchange members. Brokers provide that service and are compensated in various ways, either through commissions, fees or through being paid by the exchange itself.

Brokers offer the investors the access to financial instruments listed in the financial markets worldwide. When talking about investing through a broker; usually each time an investor identifies and purchase a security or any other financial instrument, he/she will bear transactions costs (broker fees).

Herein, transaction costs are expenses incurred when buying or selling a good or service. Transaction costs represent the labor required to bring a good or service to market, giving rise to entire industries dedicated to facilitating exchanges. In a financial sense, transaction costs include commissions and spreads of brokers, which are the differences between the price the dealer paid for a security and the price the buyer pays.

It is obvious that to build up a diversified portfolio, the investor must make many transactions.

When the size of the investment is below a certain amount, a minimum amount of transaction fees may be applied by the broker, consequently, the fees paid can be relatively high in comparison with the investment size and that reduce the profitability of the investment, making investing through brokers less efficient.

Another constraint that makes investing through brokers not always efficient is that brokers do not allow all the investors to invest or trade in derivatives, financial instruments commonly used by institutional investors (wealthy investors, investment companies, investment funds) to further reduce the portfolio risks thanks to the so-called hedging strategies.

Herein, a “derivative” is a financial security with a value that is reliant upon or derived from, an underlying asset or group of assets—a benchmark. The derivative itself is a contract between two or more parties, and the derivative derives its price from fluctuations in the underlying asset. The most common underlying assets for derivatives are stocks, bonds, commodities, currencies, interest rates, and market indexes. These assets are commonly purchased through brokerages.

Herein, “hedging” is a risk management strategy employed to offset losses in investments by taking an opposite position in a related asset. The reduction in risk provided by hedging also typically results in a reduction in potential profits. Hedging strategies typically involve derivatives, such as options and futures contracts.

The reason of such constraint is the risk associated to those instruments, as, while they are a valid instrument to further reduce the risk of the portfolio with a right use of them, the incorrect use or misunderstanding of such instruments may lead to large losses. Therefore, in most of the cases only professional, well-informed, institutional or wealthier investors have access to derivatives. A professional investor is an investor who possesses the experience, knowledge and expertise to make its own investment decisions and properly assess the risks that he incurs. Professional investors include, among others, entities which are required to be authorized or regulated to operate in the financial markets, large undertakings, and other institutional investors whose main activity is to invest in financial instrument. A well-Informed Investor is an investor who is not a professional investor and fulfils the following conditions: (a) the investor confirms in writing that he is a well-informed investor and that he is aware of the risks related with the proposed investment, and (b) either his investment in the AIF amounts, at least, to €125,000, or he is assessed as a well-informed investor, either by a credit institution that falls within the scope of the Banking Laws as amended, or by an Investment Firm, or by a UCITS management Fund and the above mentioned assessment shows that he has the necessary experience and knowledge to be able to evaluate the appropriateness of the investment in the AIF. An institutional investor is a company or organization that invests money on behalf of other people. Mutual funds, pensions, and insurance companies are examples.

Not all the brokers give access to all the existing financial instruments and/or in most of the cases not to all the investors but just to the wealthier ones, and that impedes many investors to build up an efficient and well-diversified portfolio through brokers.

Finally, through rebalancing the investor must make further transactions and that means new transaction costs that reduce the overall profitability of the portfolio.

To reduce the transaction costs, brokers and other financial institutions are making available securities in their platform without the need to place market orders each time a client (investor) wishes to buy or sell a determined security. These brokers and financial institutions act as intermediaries, giving their clients free choice to select the securities or investments funds, within a range of available securities and investment funds, but do not provide with any tailored portfolio solution. Herein, a market order is any instruction by an investor to a broker to buy or sell stock shares, bonds, or other assets at the best available price in the current financial market.

Another way to invest in a diversified portfolio are the investment funds. Investment funds are supply of capital belonging to different investors, also called fund holders or shareholders, used to collectively purchase financial instruments or other assets. Investment funds are managed by a fund manager or software in charge to make investment decisions in respect of the strategy and objectives of the investment fund.

An investment fund has a price, also called net asset value per share or NAV, calculated by summing up the value of all the assets in which the investment fund invests and deducting the fees in which it incurs and then dividing by the number of outstanding shares. Also, investment funds have much lower transaction costs in comparison to the investment size, due to the high traded volumes.

Usually, when shareholders subscribe, the cash is used by the fund manager to buy new assets. Only when the cash received is considerable, the fund manager may adjust the weighting of the assets to bring it back to the desired levels. However, when the amount received from the new shareholders is marginal or not considerable in comparison to the fund's size, he may decide not to use the cash straight away, for instance leaving it for future investments or to cover some expenses.

As the prices of the assets change every day, but the rebalancing of an investment fund is generally made only one or few times a year, shareholders buying shares of one or more funds at different dates may receive these shares having a value that does not reflect the same assets weighting.

For the sake of illustration, one can consider an investment fund with no fees, with an investment in 4 stocks (stock A, stock B, stock C and stock D) and the desired level of risk being met if the weight of each stock in the fund is 25%. One can consider that the investment fund has one investor that has invested an amount of 1.000.000 euros into the fund, paying 100 per share so as to obtain 10.000 shares. Since the 25% weight of each stock represents the desired allocation and level of risk, it implies that the fund manager has invested 1.000.000 euros by purchasing shares of each stock for a corresponding value of 1.000.000*25%=250.000 euros. Consequently, the contribution of each stock into the fund price is 100*25%=25.

In the above example, the following assumptions are now considered regarding price levels and quantities of the stocks A, B, C and D at two given times t1 and t2. It is considered that 50000 shares of the stock A have been acquired, 25000 shares of the stock B have been acquired, 10000 shares of the stock C have been acquired and that 5000 shares of the stock D have been acquired:

TABLE 2

| | Stock A | Stock B | Stock C | Stock D |
|---|---|---|---|---|
| Price of a | 5 | 10 | 25 | 50 |
| share at time | | | | |
| t1 | | | | |
| Price of a | 7.5 | 9 | 20 | 60 |
| share at time | | | | |
| t2 | | | | |
| Weight at | 34.09% | 20.45% | 18.18% | 27.27% |
| time t2 | | | | |

Since the quantities for each stock did not change, the total value of the assets is now equal to (50.000*7.5)+(25.000*9)+(10.000*20)+(5.000*60) euros, namely 1.100.000 euros. The NAV is then equal to ((50.000*7.5)+(25.000*9)+(10.000*20)+(5.000*60))/10.000, namely 110. This implies that the weights of each stock in the investment fund have changed, and the values of the weights can be computed as those provided in Table 2.

The contribution of each stock into the fund price mirrors the new stocks weighting. It is obvious that if a second investor invests a marginal amount in the same fund, that is not used by the fund manager, the level of risk for the second investor will be different compared to the level of risk of the first investor.

Among the known types of investment funds, not all of them are accessible to all investors. The most common investment funds accessible to all the investors are mutual funds and exchange traded funds. A mutual fund is a type of financial vehicle made up of a pool of money collected from many investors to invest in securities like stocks, bonds, money market instruments, and other assets. Mutual funds are operated by professional money managers, who allocate the fund's assets and attempt to produce capital gains or income for the fund's investors. A mutual fund's portfolio is structured and maintained to match the investment objectives stated in its prospectus.

An exchange traded fund, or ETF, is a type of security that tracks an index, sector, commodity, or other asset, but which can be purchased or sold on a stock exchange the same as a regular stock. An ETF can be structured to track anything from the price of an individual commodity to a large and diverse collection of securities.

Mutual funds and ETFs are regulated, meaning there are subject to specific rules that put limitations in the investment strategies and techniques of the fund to protect the investors.

Mutual funds pursue different strategies defined in the fund prospectus, a statement that describes the fund, investment strategy, investment objectives, risk factors, fee structure and all the parties involved in the funds' activities. A mutual fund prospectus is a document detailing the investment objectives and strategies of a particular fund or group of funds, as well as the finer points of the past performance of the fund, managers and financial information.

A mutual fund is usually an “actively managed” fund, meaning the fund manager aims to better perform than a determined target (reference) market index, however the fees paid by the fund to reward the fund manager for his work (so-called management fees) as well as the fees for the administration of the operations and duties of the fund, reduce the portfolio performance.

Herein, “active management” refers to a management strategy in the attempt to outperform a specific index. With “passive management”, the portfolio is designed to parallel the returns of a particular market index or benchmark as closely as possible.

The strategy of a fund refers to the asset class(es) and/or geographic area(s) and/or economic sector(s) in which the fund is invested in. The fund manager of a mutual fund makes the investment decisions based on the fund investment strategy and objectives as per fund prospectus. While the prospectus describes the investment strategy, it does not show the exact portfolio composition that the fund should have, therefore the fund manager has some free room to make his own decisions.

Each time a new investor purchases or subscribes a mutual fund, he receives new shares in exchange of the money he brings. The number of shares is calculated by dividing the amount invested with the fund price. Fees may be deducted before calculating the number of shares, for instance in the form of subscription fees or upfront fees. Herein, “subscribe a fund” refers to the subscription of the shares of said fund. A subscription agreement is the application of an investor to join a limited partnership. It is also a two-way guarantee between a company and a new shareholder (subscriber).

When new shares are subscribed, the shares and the name of the shareholder are recorded in the register of the shareholder, which results in an increase of the number of outstanding shares of the fund.

If a shareholder wishes to disinvest his money, his shares are cancelled from the register of the shareholders and consequently the number of shares of the fund decreases. Fees may also apply when the investor redeems his shares. The number of shares of a mutual fund is theoretically unlimited.

The shareholders of a mutual fund are owner of the fund shares, which value changes depending on the price fluctuation of the assets and on the fees in which the fund incurs. The shareholders of a fund are therefore not owner of the assets in which the fund invests, and they are not necessarily supposed to know the exact portfolio composition of the fund. The other investment vehicle accessible to all the investors is the ETF, a fund in which the transfer of the shares is done on a stock exchange.

Herein, an investment vehicle is a product used by investors to gain positive returns. Investment vehicles can be low risk, such as certificates of deposit (CDs) or bonds, or they can carry a greater degree of risk, such as stocks, options, and futures. Other types of investment vehicles include annuities, collectibles, such as art or coins, mutual funds, and ETFs.

Like any other instrument listed on a stock exchange market, investors incur in transaction costs when buying or selling shares of an ETF. An ETF like a mutual fund has a reference index, however the ETF usually aims to replicate the performance of the reference index; for this reason, ETFs are also generally “passive” funds. To replicate the index performance, the fund manager of an ETF makes sure that the portfolio composition is made up with the same securities of the reference index and in the same proportion (same assets weighting). ETFs, for their nature to be traded on a stock exchange, for the fact that usually do not aim to better perform the reference index (the strategy requires less analysis by the fund manager and in many cases the rebalancing is automated) and as it has less duties than a mutual fund, generally incur in less fees than a mutual fund. The portfolio composition of an ETF; or at least the composition of the main assets; is generally made available; in some cases, the portfolio composition may deviate from the composition of the reference index. If the trading currency of the ETF is other than the currency of the reference index, the performance of the ETF may deviate from the performance of the reference index, unless the fund manager puts in place a strategy to protect the ETF from the currency fluctuations (currency hedging or forex hedge). Such strategy may lead to further fees for the ETF.

Herein, trading currency refers to the currency in which the financial instrument is traded on the financial market. A forex hedge is a transaction implemented to protect an existing or anticipated position from an unwanted move in exchange rates.

While ETFs are commonly “passive” funds, “actively” managed ETFs also exist, however these incur in more fees than the “passive” ones.

Among the other types of funds, there are few not accessible to all the investors, particularly to those ones not having large capitals. Private equity funds are funds, investing in small-medium size companies, where investors are committed to bring a determined capital amount that is partially or totally paid, once the fund manager, the person in charge to make the investment decisions, finds an investment opportunity and needs money to pay the company chosen.

Herein, “private equity” funds are closed-end funds that are considered an alternative investment class. Because they are private, their capital is not listed on a public exchange. These funds allow high-net-worth individuals and a variety of institutions to directly invest in and acquire equity ownership in companies. Due to the illiquid nature of the target investments, each investor should have a solid financial situation to guarantee the payment of the capital committed.

Similar to private equity funds, private debt funds are closed-end funds, with limited number of wealthy and institutional investors, operating in the private credit, in which growing companies seeking for funding, raise money through debts not issued or traded on the public markets (e.g., “direct lending” or “private lending”). Private credit is an asset defined by non-bank lending where the debt is not issued or traded on the public markets. Private credit can also be referred to as “direct lending” or “private lending”. It is a subset of “alternative credit”. Direct lending is a form of corporate debt provision in which lenders other than banks make loans to companies without intermediaries such as an investment bank, a broker or a private equity firm. In direct lending, the borrowers are usually smaller or mid-sized companies, also called small and medium enterprises, rather than large, listed companies, and the lenders may be wealthy individuals or asset management firms.

Hedge funds are investment funds which shares can be owned only by accredited investors with a significant amount of wealth. The reason of that is because of their investment strategies, that make hedge funds be considered high-risk investment vehicles. Hedge funds aim to maximize the return in any condition of the financial markets and that is pursued with the use of complex techniques.

Among these techniques, few of them could potentially lead the hedge fund to incur in large losses. One example is the use of leverage, which results from using borrowed capital as a funding source when investing to expand the asset base of a firm and generate returns on risk capital. Thus, leverage is an investment strategy of using borrowed money—specifically, the use of various financial instruments or borrowed capital—to increase the potential return of an investment.

However, leverage makes the hedge fund be overexposed, meaning the hedge fund is invested in much more assets than what it can purchase by only using the money of the investors. For instance, assuming a total amount of money being 100 euros, if the fund manager invests such 100 euros, the maximum possible loss for the fund is 100 that can happen if all the companies in which the fund invests in go bankrupt, making their share price drop to zero.

With the use of the leverage, the fund manager can borrow money to invest, for instance 500 euros in the same securities as the previous scenario. In this case the hedge fund is applying a leverage of 500/100, equal to 5. If the price of all the securities in which the hedge fund invests in drop to zero the loss for the fund will be 500 euros, making the investors incur in a loss 5 times bigger than the money they have invested into the fund.

The risky nature of the techniques used by hedge funds make them therefore not suitable for investors with limited financial resources.

### SUMMARY

An object of the present disclosure is to provide a diversified portfolio of assets allocated from a pool of assets to investors with tailored quantities allocation based on determined asset weightings and level of risk.

An object of the present disclosure is also to provide a method and a corresponding system for facilitating the access to a diversified portfolios of securities and/or any type of financial instruments, said system comprising software applications. Securities and/or financial instruments are purchased on the market in large quantities and then made available and allocated to individual investors, which holdings are recorded in a ledger.

The above-mentioned objects are substantially achieved by the present disclosure that in a first aspect provides a method for determining a weighting of a diversified security portfolio, wherein the method comprises:
a) receiving, by a first module, a security from an asset database, said first module being called portfolio parameterization module,
b) upon receipt of the security, configuring, by the first module, said diversified security portfolio based on predetermined parameters, said predetermined parameters being transmitted by at least one asset management module to the first module,
c) determining, by a second module, the weighting of the configured diversified security portfolio, said determining being based on current market data parameters provided by one or more servers, said current market data parameters comprising market capitalization of the security, volatility of the security and correlation between securities, said second module being called key parameter monitoring and rebalancing module, and
d) transmitting, by a third module, the determined weighting to a user interface, said third module being called transactions management module.

According to an optional embodiment, the current market data parameters is provided by the one or more servers to the first module and/or to the user interface with a predetermined frequency, said predetermined frequency being yearly, weekly, daily, hourly or every minute.

According to an optional embodiment, the determining of the weighting and the the monetary value of the allocated securities is used to calculate the value of the parts of a diversified security portfolio to hedge or the diversified security portfolio to hedge when allocating derivatives.

Herein, the term “investor” refers to any entity or person committing capital with the expectation of receiving returns, such as financial returns. Investors can be individuals, corporations or organizations willing to purchase (subscribe) a portfolio, such as a diversified portfolio.

Herein, and for the purpose of the present disclosure, a “pool of assets” refers to a set, or a “basket”, of different securities and financial instruments. Herein, and for the purpose of the present disclosure, a “portfolio” or “client portfolio” refers to a set of assets which is part of the pool of assets, or portfolio of assets, which is allocated to one or more investors.

Herein, the term “holdings” refers to the contents of any investment portfolio held by an entity or person, such as a mutual fund or a pension fund. Herein, the term “ledger” refers here to any kind of file or book being automatically managed by a software in which transactions and investors' holdings are recorded. Herein, the term “portfolio weight” is the percentage of a holding into the portfolio. The most basic way to determine the weight of an asset is by dividing the value of a security by the total value of the portfolio.

This provides a “customized quantities allocation” technique, that is, a technique to calculate the holding quantities by a given user, or investor, to meet predetermined securities weighting.

Furthermore, the method allows each investor to receive holding quantities calculated in a way to meet a determined risk level and portfolio weighting, irrespective of the date when the investor purchases the portfolio and the consequent holdings prices levels.

This provides better investment protection by providing an optimal situation based on weightings and/or risk levels, directly adapted to market data, which is updated regularly, preferably daily. In the specification, the term «weighting» and «risk level» will be considered equivalent.

According to an embodiment, the configuring comprises transferring a number of shares of said security from the asset database to the first module or transferring a number of shares of said security from the first module to the asset database for modifying a percentage of the security present in the diversified security portfolio.

Herein, the expression “modifying a percentage of the security” is equivalent to the expression “rebalancing the weight of the stocks corresponding to the security”. The expression “transferring of a number of shares of the security” is equivalent to “purchasing”, selling or allocating the shares of the stock corresponding to the security”. The expression “modifying a percentage of the security present in the diversified security portfolio” is equivalent to “rebalancing the weight of the stock corresponding to the security”.

According to an optional embodiment, the determining of the weightings is carried out by the at least one asset management module. As a preliminary step of the determining of the weightings, the at least one asset management module sets up a design, one or more risk limits and weighting thresholds of the diversified security portfolio, said weighting thresholds being set to avoid overexposure of the diversified security portfolio. As a first step of the determining of the weightings, an initial weightings calculation is computed by the first module based on market capitalization of the companies taking part in the diversified security portfolio and weighting thresholds. As a second step of the determining of the weightings, the initial weightings are applied and the correlation between securities and the securities volatility are computed so as to obtain a starting portfolio volatility. As a third step of the determining of the weightings, the risk limits, the correlation between securities and the securities volatility are applied to determine final weightings.

According to an optional embodiment, the determining of the final weightings take in consideration that the final weightings cannot deviate more than a determined threshold from the initial weightings.

According to an embodiment, the method further comprises e) storing, by a fourth module, a plurality of fee matrices, said fee matrices comprising at least one fee among an entry fee, an exit fee, a management fee and a performance fee of the security, the fourth module being further configured for determining transaction instructions of the security to be carried out, said fourth module being called fee management module.

According to an embodiment, the method further comprises f) storing, by a fifth module, static data provided by the third module and/or for receiving transaction instructions provided by the fourth module, said fifth module being called client portfolio management module.

According to an embodiment, the method further comprises g) computing, by a sixth module, a dividend, a coupon, an asset price and/or an exchange rate of the security of the diversified security portfolio, the computing being based on the current market data parameters and on the determined weighting, said sixth module being called corporate action management module.

According to an embodiment, the receiving, the configuring, the determining and the transmitting are carried out iteratively for the security as long as the value of the weighting is smaller than a predetermined level.

This enables limiting the risk level for including a given security in the diversified security portfolio, thus preventing users from shorting the total quantities available for that security.

According to an embodiment, the method further comprises h) validating, by a seventh module, the transferring of a number of shares of the security from the asset database to the first module, the transferring a number of shares of said security from the first module to the asset database or a transaction instruction of the security to be carried out, said seventh module being called reconciliation and exception management module.

According to an embodiment, the method further comprises i) providing the user interface, by a eighth module, with a notification message, said notification message comprising at least one of an information of the diversified security portfolio, a transaction suggestion of the security in the diversified security portfolio and a service improvement suggestion, said eighth module being called reward management module.

The above-mentioned objects are substantially achieved by the present disclosure that in a second aspect provides a system for determining a weighting of a diversified security portfolio, wherein the system comprises:
a first module, called portfolio parameterization module, configured for receiving a security from an asset database and configuring, upon receipt of the security, said diversified security portfolio based on predetermined parameters, said predetermined parameters being transmitted by at least one asset management module to the first module,
a second module, called key parameter monitoring and rebalancing module, configured for determining the weighting of the configured diversified security portfolio based on current market data parameters provided by one or more servers, said current market data parameters comprising market capitalization of the security, volatility of the security and correlation between securities, and
a third module, called transactions management module, configured for transmitting the determined weighting to a user interface.

According to an embodiment, the system further comprises a fourth module, called fee management module, configured for storing a plurality of fee matrices, said fee matrices comprising at least one fee among an entry fee, an exit fee, a management fee and a performance fee of the security, the fourth module being further configured for determining transaction instructions of the security to be carried out.

According to an embodiment, the system further comprises a fifth module, called client portfolio management module, configured for storing static data provided by the third module and/or for receiving transaction instructions provided by the fourth module.

This allows reflecting the history of transactions which can impact the diversified security portfolio

According to an optional embodiment, the fifth module is further configured for reporting said stored static data to the user interface.

According to an optional embodiment, the fifth module is further configured for forwarding the received transaction instructions to the user interface.

According to an embodiment, the system further comprises a sixth module, called corporate action management module, configured for computing a dividend, a coupon, an asset price and/or an exchange rate of the security of the diversified security portfolio, the computing being based on the current market data parameters and on the determined weighting.

In another aspect, it is proposed a computer software comprising instructions to implement at least a part of a method as defined here when the software is executed by a processor.

In another aspect, it is proposed a computer-readable non-transient recording medium on which a software is registered to implement the method as defined here when the software is executed by a processor.

### BRIEF DESCRIPTION OF DRAWINGS

Other features, details and advantages will be shown in the following detailed description and on the figures, on which:

FIG. 1 is a system of modules according to an embodiment.

FIG. 2 is a process according to an embodiment for achieving high level purchase.

FIG. 3 is a process according to an embodiment for achieving high level disbursement.

FIG. 4 is a process according to an embodiment for achieving high level rebalancing.

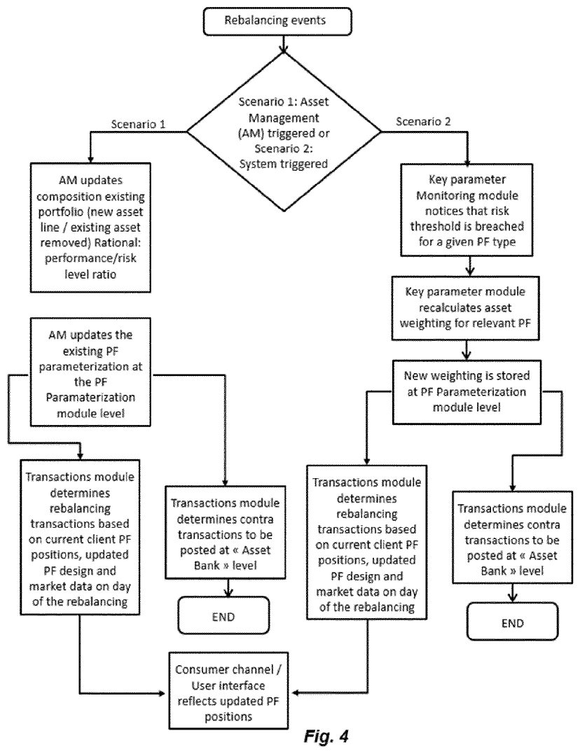

Unless otherwise indicated, features common to or similar to several figures bear the same reference signs and refer to identical or elements, so that these common features are generally not described again for the sake of simplicity.

### DETAILED DESCRIPTION

The embodiments of the present disclosure provide a method that allows investors to access a diversified portfolio of securities and other financial instruments with one single transaction and without the need of buying each security on the market and therefore without incurring many transaction costs and fees.

The securities and other financial instruments are in fact purchased in large volumes so as to reduce the transaction costs and are held in a pool of assets. Thus, the embodiments of the present disclosure provide a method that allows allocating a group of securities (client portfolio) to one or more investors through a ledger without the need for the investor to purchase each security on the financial markets and therefore to bear the full cost and fees for each transaction. The quantities are allocated to each investor in a way to meet a determined weighting and overall portfolio risk level. A corresponding ledger can be managed by a system as described hereafter.

In the following, one or more securities of the pool of assets can be made available for investors who wish to build their own portfolio, with the constraint that the investors cannot invest more than a determined percentage of the invested money in a single security. This enables enforcing the diversification of their portfolio.

Herein, groups of securities and financial instruments are classified by economic sector, geographic area, theme. Each group contains a certain quantity of each security to meet a determined weighting, so as to align the level of risk across the investors.

In an embodiment, the determination of the level of risk and securities weightings is managed by algorithmic support such as a computer software comprising instructions to implement at least a part of a method as defined here when the software is executed by a processor.

In an embodiment, said instructions take in consideration the volatility of the securities, the correlation between securities and the market capitalization. Said instructions can further take in consideration the value of the portfolio and/or the value of the parts of the portfolio to hedge when allocating the derivatives for hedging purposes.

Herein, the “market capitalization” refers to the total market value of a company's outstanding shares of stock. Commonly referred to as “market cap,” it is calculated by multiplying the total number of outstanding of a given company or business shares by the current market price of one share. As an example, a company with 10 million shares selling for a value of 100 each, e.g. 100 US dollars, would have a market cap of one billion. This figure reflects the size of the given company or business, as opposed to using sales or total asset figures.

The determining of the weightings of the diversified security portfolio relies directly on current market data parameters provided to the system and which comprise at least the market capitalization of the securities in the diversified security portfolio, the volatility of the securities as well as the correlation between these securities.

In order to carry out this determination of the weightings, an algorithm is set up to calculate the overall portfolio volatility taking in consideration the overall adjusted market capitalization of the companies composing the portfolio and the adjusted market capitalization of each single company.

Herein, the adjusted market capitalization is equivalent to the sum of the market capitalization of the companies of a given portfolio, if the weighting of one or more companies exceeds a given threshold set to avoid overexposure. The market capitalization of this company or these companies can then be adjusted to meet the maximum weighting allowed.

For instance, it can be assumed that a company A has a market cap of 50, a company B has a market cap of 20, a company C has a market cap of 20 and a company D has a market cap of 10. The algorithm will ensure that none of the corresponding securities exceeds 30% of the overall portfolio. In that case, company A will have a weighting of 50% and because of that, the market cap of company A and company B to consider will be 15 so that overall market cap will be equal to 50. In this simplified example with 4 companies, the weighting of company A and company B will then be 30%.

Once determined the adjusted market capitalization, a starting portfolio volatility is generated for a given correlation between the securities and depending on the volatility of each security.

If the starting portfolio volatility exceeds the volatility that we have set for the portfolio, the algorithm will generate weighting scenarios in which the portfolio volatility threshold is met. The correlation and volatility are provided so that the algorithm keeps the same volatility and correlation, taking in consideration that the weighting of each security cannot deviate by a determined threshold, such as +/−2% from the adjusted market capitalization.

In possible embodiments, the algorithm can be set to validate scenarios meeting other criterions or parameters, such as according to waterfall rules in case there are more scenarios that meet the volatility threshold. If it is not possible to meet the volatility threshold, the algorithm can further adjust the market capitalization until when the threshold is met.

When carrying out the method, the investors get allocated quantities of each security that may vary depending on the market price of each security on the day they subscribe. The allocation of the quantities is managed in connection with the determined level of risk of the portfolio and securities weightings.

In the following, an embodiment is described for the case of a pool of assets having four stocks A, B, C and D, each of these stocks having a 25% weighting. It is further considered that each investor is willing to invest a value of 500, said value being preferably a monetary quantity such as a value expressed in euros, dollars USD, pounds GBP, or any type of currency. The value of 500 can also refers to cryptocurrencies, such as bitcoins.

It is understood that the present embodiment, and the present disclosure, is generalizable to any number of stocks, prices, and weightings. Generally, the weighting of each security in a portfolio is different.

When a first investor, hereafter called “investor 1” subscribes the portfolio, the market prices of each stock are as indicated in Table 3 below, which shows the number of shares in the theoretical portfolio, which is calculated based on the hypothetical stock weightings and stock market prices and on a hypothetical amount invested by an investor. Quantities fractions are rounded to four decimal places in the following tables for the example purposes only.

TABLE 3

| | | | Number of |
|---|---|---|---|
| | | | allocated |
| | Stock weighting | Stock price | shares |
| Stock A | 25% | 1.5 | 83.3333 |
| Stock B | 25% | 2 | 62.5 |
| Stock C | 25% | 3 | 41.6666 |
| Stock D | 25% | 1 | 125 |
| Amount spent | | 500 | |
| by investor 1 | | | |

When a second investor, hereafter called “investor 2” subscribes the portfolio after the first investor, a few days later, the market prices of each stock may be as indicated in Table 4 below, which shows the number of shares or quantity in the theoretical portfolio. These are calculated based on the hypothetical stock weightings like in Table 3 and hypothetical stock market prices deviating from Table 3 and on the same hypothetical amount invested from Table 3.

TABLE 4

| | | | Number of |
|---|---|---|---|
| | | | allocated |
| | Stock weighting | Stock price | shares |
| Stock A | 25% | 1.8 | 69.4444 |
| Stock B | 25% | 2.1 | 59.5238 |
| Stock C | 25% | 2.8 | 44.6428 |
| Stock D | 25% | 0.9 | 138.8888 |
| Amount spent | | 500 | |
| by investor 1 | | | |

The overall quantities allocated to all the investors cannot exceed the total quantities available in the pool of assets. When market prices rise from the levels at which they have been purchased to build up the pool of assets, more portfolios are available for the investors (as the quantities allocated to each investor decrease) and less portfolios are available when the market prices drop.

It is now assumed that Stock A, Stock B, Stock C and Stock D have been purchased in a quantity that equals to 25% of the overall money spent to build up the pool of assets, multiplied by the market price so that the purchased value (cost) of each stock in the pool of assets is the same (as each stock has the same weighting in the hypothetical example).

It is further assumed that each stock has been purchased at the same prices as investor 1 as per previous sample and the overall money spent for the pool of assets is 100000. Fractions of stock shares cannot be traded on the market. Therefore, the quantities are here rounded to the closest unit.

Table 5 below shows the number of shares or quantity in the theoretical portfolio, which is calculated based on the hypothetical stock weightings like in Table 3 and hypothetical stock market prices like in Table 3 and on hypothetical amount invested different from Table 3.

TABLE 5

| | | | Amount spent | |
|---|---|---|---|---|
| | Stock | Stock | by the | Quantity |
| | weighting | price | company | purchased |
| Stock A | 25% | 1.5 | 25000 | 16666.67 |
| Stock B | 25% | 2 | 25000 | 12500.00 |
| Stock C | 25% | 3 | 25000 | 8334.00 |
| Stock D | 25% | 1 | 25000 | 25000.00 |
| Amount | | | 100000 | |
| invested by | | | | |
| company | | | | |

Because it has been assumed that each investor is willing to pay 500, if the market prices remain the same, 100.000/500=200 client portfolios will be available to the investors. This happens for example if all the investors subscribe the same day when the stocks are purchased, like investor 1 of the previous example.

Table 6 below shows the number of possible portfolios that can be offered to the investors based on the hypothetical stock weightings like in Table 3 and in Table 4, and stock market prices like in Table 3, assuming all the investors invest the same amount from Tables 3 and 4.

TABLE 6

| | | | | | Number of |
|---|---|---|---|---|---|
| | | | | Number of | shares |
| | | | | shares | allocated |
| | Quantity | Stock | | allocated to | based on |
| | available | weighting | Stock price | each portfolio | market prices |
| Stock A | 16667.00 | 25% | 1.5 | 83.3333 | 200 |
| Stock B | 12500.00 | 25% | 2 | 62.5000 | 200 |
| Stock C | 8334.00 | 25% | 3 | 41.6666 | 200 |
| Stock D | 25000.00 | 25% | 1 | 125.0000 | 200 |
| Amount paid | | 500 | | 100000 | 200 |
| by each | | | | | |
| investor | | | | | |
| Number of | | 200 | | | |
| possible | | | | | |
| portfolios | | | | | |

It is now assumed all the investors subscribe on the same day as “investor 2”, when Stock A and Stock B have increased their price, while the prices Stock C and Stock D have dropped. Because the condition 25% weighting for each stock must be met, the number of client portfolios that can be allocated is as provided in Table 7 below.

Specifically, Table 7 below shows the number of possible portfolios that can be offered to the investors based on the hypothetical stock weightings like in Table 3 and in Table 4, and stock market prices like in Table 4, assuming all the investors invest the same amount from Tables 3 and 4.

TABLE 7

| | | | | | Number of |
|---|---|---|---|---|---|
| | | | | Number of | shares |
| | | | | shares | allocated |
| | Quantity | Stock | | allocated to | based on |
| | available | weighting | Stock price | each portfolio | market prices |
| Stock A | 16667.00 | 25% | 1.8 | 69.4444 | 240 |
| Stock B | 12500.00 | 25% | 2.1 | 59.5238 | 210 |
| Stock C | 8334.00 | 25% | 2.8 | 44.6428 | 187 |
| Stock D | 25000.00 | 25% | 0.9 | 138.8888 | 180 |
| Amount paid | | 500 | | | |
| by each | | | | | |
| investor | | | | | |
| Number of | | 180 | | | |
| possible | | | | | |
| portfolios | | | | | |

As the market price of Stock D has decreased, the quantity allocated in each client portfolio increases, therefore, the number of possible client portfolios that can be allocated to the investors by keeping the 25% weighting for each stock is 180, which is the lowest of the ratio of available shares versus the number of shares allocated based on current market prices as calculated for each stock. Still assuming that each investor is willing to invest 500, it implies that there will be quantities of Stock A, Stock B and Stock C that will remain unallocated. Of course, the pool of assets can be fed with further quantities of Stock D purchased on the market, so that together with the remaining quantities of Stock A, Stock B and Stock C further client portfolios can be made available, in which, the condition 25% weighting per stock is still met. Should the market prices increase, the number of possible client portfolios will increase as well.

It is now assumed that no investor has yet subscribed to a portfolio and that the prices increase for the 4 stocks to reach the levels of 2.0 for Stock A, 2.50 for Stock B, 3.50 for Stock C and 1.20 for Stock D.

In such a case, Table 8 below shows the number of possible portfolios that can be offered to the investors based on the hypothetical stock weightings like in Table 3 and in Table 4, and stock market prices deviating from Table 3 and from Table 4, assuming all the investors invest the same amount from Tables 3 and 4.

TABLE 8

| | | | | | Number of |
|---|---|---|---|---|---|
| | | | | Number of | shares |
| | | | | shares | allocated |
| | Quantity | Stock | | allocated to | based on |
| | available | weighting | Stock price | each portfolio | market prices |
| Stock A | 16667.00 | 25% | 2 | 62.5000 | 267 |
| Stock B | 12500.00 | 25% | 2.5 | 50.0000 | 250 |
| Stock C | 8334.00 | 25% | 3.5 | 35.7142 | 233 |
| Stock D | 25000.00 | 25% | 1.2 | 104.1666 | 240 |
| Amount paid | | 500 | | | |
| by each | | | | | |
| investor | | | | | |
| Number of | | 233 | | | |
| possible | | | | | |
| portfolios | | | | | |

Therefore, the result of the ratio of available shares versus the number of shares allocated based on current market prices for Stock C equals to the number of possible client portfolios that can be offered to the investors.

If “investor 1” subscribes on day 1, only the remaining quantities can be allocated to further client portfolios If considering the prices as previously, the number of possible client portfolios left will be as in Table 9 below, which shows the number of remaining possible portfolios that can be offered to the investors based on the hypothetical stock weightings and stock market prices like in Table 8, assuming all the investors invest the same amount from Table 3 and from Table 3, and after the first investor has purchased one portfolio.

TABLE 9

| | | | | | Number of |
|---|---|---|---|---|---|
| | | | | Number of | shares |
| | | | | shares | allocated |
| | Quantity | Stock | | allocated to | based on |
| | available | weighting | Stock price | each portfolio | market prices |
| Stock A | 16583.67 | 25% | 2 | 62.5000 | 265 |
| Stock B | 12437.50 | 25% | 2.5 | 50.0000 | 249 |
| Stock C | 8291.33 | 25% | 3.5 | 35.7142 | 232 |
| Stock D | 24875.00 | 25% | 1.2 | 104.1666 | 239 |
| Amount paid | | 500 | | | |
| by each | | | | | |
| investor | | | | | |
| Number of | | 232 | | | |
| possible | | | | | |
| portfolios | | | | | |
| after investor | | | | | |
| 1 | | | | | |

The remaining quantities have fractions as there is no transaction processed on the market, where stocks shares can be only traded in units, but the securities are allocated internally by the ledger from the pool of assets to the investor(s).

So far, it has been assumed that each investor is willing to pay 500. In general, the resources and objectives of investors are different. In the case where different amounts of investments are performed by the other investors, there can be a very number of possible scenarios on how to determine the number of client portfolios available, depending on how much each investor invests and how many investors are willing to invest.

In principle, the investor who invests first has a larger quantity of securities available than the investors who invest later, unless the pool of assets is fed with more securities purchased on the market.

It is now assumed that only three investors are willing to invest: “investor 1” has 1500 to invest, “investor 2” has 40000 to invest and “investor 3” 60000. “Investor 1” subscribes his client portfolio on the day when the prices are like in Table 3, so that he will obtain the quantities as allocated in Table 10 below, which shows the number of shares or quantity in the theoretical portfolio. These values are calculated based on the hypothetical stock weightings and stock market prices like in Table 3, and a hypothetical amount invested deviating from Tables 3 and 4, further showing the remaining available stocks quantities after deducting the number of shares of the theoretical portfolio of the corresponding Table.

TABLE 10

| | | | | | Number of |
|---|---|---|---|---|---|
| | | | | | shares |
| | | | | | available |
| | | | | Number of | after |
| | | | | shares | investment |
| | Quantity | Stock | | allocated to | from investor |
| | available | weighting | Stock price | investor 1 | 1 |
| Stock A | 16667.00 | 25% | 1.5 | 250.0000 | 16417.0000 |
| Stock B | 12500.00 | 25% | 2 | 187.50000 | 12312.5000 |
| Stock C | 8333.00 | 25% | 3 | 125.0000 | 8208.0000 |
| Stock D | 25000.00 | 25% | 1 | 375.0000 | 24625.0000 |
| Amount | | 1500 | | | |
| invested by | | | | | |
| investor 1 | | | | | |

If it is assumed that “investor 2” decides to invest his 40.000 on the day when the stock prices are like in Table 7, Table 11 below will provide the number of shares or quantities in the corresponding theoretical portfolio, which are calculated based on the hypothetical stock weightings and stock market prices like in Table 4 and a hypothetical amount invested deviating from Tables 3, 4 and 10, further showing the remaining available stocks quantities after deducting the number of shares of the theoretical portfolio of Table 10 and showing the number of shares of the theoretical portfolio of the same figure.

TABLE 11

| | | | | | Number of |
|---|---|---|---|---|---|
| | | | | | shares |
| | | | | | available |
| | | | | Number of | after |
| | | | | shares | investment |
| | Quantity | Stock | | allocated to | from investor |
| | available | weighting | Stock price | investor 2 | 2 |
| Stock A | 16417.00 | 25% | 1.8 | 5555.5555 | 10861.4445 |
| Stock B | 12312.50 | 25% | 2.1 | 4761.9047 | 7550.5953 |
| Stock C | 8208.00 | 25% | 2.8 | 3571.4285 | 4636.5715 |
| Stock D | 24625.00 | 25% | 0.9 | 11111.1111 | 13513.8889 |
| Amount | | 40000 | | | |
| invested by | | | | | |
| investor 2 | | | | | |

Table 12 below shows the number of shares or quantity in the theoretical portfolio if “investor 3” subscribes the day when the stock prices are like in Table 9. Table 12 is obtained based on the hypothetical stock weightings and stock market prices like in Table 8 and a hypothetical amount invested deviating from Tables 3, 4, 10 and 11. The remaining available stocks quantities are showed after deducting the number of shares of the theoretical portfolio of Tables 10 and 11, further showing the number of shares of the theoretical portfolio of the corresponding Table.

TABLE 12

| | | | | | Number of |
|---|---|---|---|---|---|
| | | | | | shares |
| | | | | | available |
| | | | | Number of | after |
| | | | | shares | investment |
| | Quantity | Stock | | allocated to | from investor |
| | available | weighting | Stock price | investor 3 | 3 |
| Stock A | 10861.44 | 25% | 2 | 7500.0000 | 3361.4445 |
| Stock B | 7550.60 | 25% | 2.5 | 6000.0000 | 1550.5953 |
| Stock C | 4636.57 | 25% | 3.5 | 4285.7142 | 350.8573 |
| Stock D | 13513.89 | 25% | 1.2 | 12500.0000 | 1013.8889 |
| Amount | | 60000 | | | |
| invested by | | | | | |
| investor 3 | | | | | |

As the market prices have increased, “investor 3” gets allocated proportionally less shares than “investor 2”. As a consequence, after the subscription of “investor 3”, there are still quantities unallocated for an additional “investor 4”.

It is now assumed that this new “investor 4” wishes to invest 15000 and, to achieve this, decides to subscribe on the same day as “investor 3” with an order coming after “investor 3” and with identical stock prices.

Table 13 below shows the number of shares or quantity in this theoretical portfolio, which is calculated based on the hypothetical stock weightings and stock market prices like in Table 8 and a hypothetical amount invested deviating from Tables 3, 4, 10, 11 and 12, showing the remaining available stocks quantities after deducting the number of shares of the theoretical portfolio of Tables 10, 11 and 12, further showing the number of shares of the theoretical portfolio of the corresponding Table, with the hypothetical assumption that the remaining quantities can be negative.

TABLE 13

| | | | | | Number of |
|---|---|---|---|---|---|
| | | | | | shares |
| | | | | | available |
| | | | | Number of | after |
| | | | | shares | investment |
| | Quantity | Stock | | allocated to | from investor |
| | available | weighting | Stock price | investor 4 | 4 |
| Stock A | 3361.44 | 25% | 2 | 1875.0000 | 1486.4445 |
| Stock B | 1550.60 | 25% | 2.5 | 1500.0000 | 50.5953 |
| Stock C | 350.86 | 25% | 3.5 | 1071.4285 | −720.5712 |
| Stock D | 1013.89 | 25% | 1.2 | 3125.0000 | −2111.1111 |
| Amount | | 60000 | | | |
| invested by | | | | | |
| investor 4 | | | | | |

By applying the same allocation and allowing “investor 4” to invest 15000, the quantities that would be available after “investor 4” subscribed for stock C and stock D will be negative. This would come with a larger risk since there will be an overall number of shares allocated to the four investors greater than the shares available in the pool of assets.

The risk allocating to multiple investors more shares than what is available can be computed under the assumption that, a few days later, the four investors decide to disinvest their portfolio. In that case, the investors get an amount equivalent to the total number of shares allocated for each stock multiplied by the market price on the day when they decide to disinvest. To disburse the investors, the stocks are then sold on the market, assuming there is no or not enough cash reserve to pay the investors. It is further assumed here that the prices of Stock A and Stock B have remained the same while the prices of Stock C and Stock D stocks have doubled. It is also assumed that the prices at which the stocks have been sold equal to the prices applied to pay back the investors and that there are no transaction costs applied on the sells on the market. No fees are applied to the investors for disinvesting.

Table 14 below shows the net amount difference between the sum of the quantities like in Tables 9, 10, 11 and 12 multiplied by hypothetical stock market prices and the quantities like in Table 5, multiplied by the same hypothetical stock market prices.

TABLE 14

| | | | | | | Net cash |
|---|---|---|---|---|---|---|
| | | | | | Amount | flow from |
| | | | | | received | sells on the |
| | Amount | | | Amount | from the | market and |
| | allocated to | Amounts | | paid back | company | payments |
| | investors 1, | available in | Stock | to investors | by selling | to investors |
| | 2, 3, 4 | the portfolio | price | 1, 2, 3, 4 | the stocks | 1, 2, 3, 4 |
| Stock A | 15180.59 | 16667.00 | 2 | 30361.1110 | 33334.0000 | 2972.8890 |
| Stock B | 12449.40 | 12500.00 | 2.5 | 31123.5118 | 31250.0000 | 126.4883 |
| Stock C | 9053.57 | 8333.00 | 7 | 63374.9984 | 58331.0000 | −5043.9984 |
| Stock D | 27111.11 | 25000.00 | 2.24 | 60728.8889 | 56000.0000 | −4728.8889 |

From Table 14, it can be understood that the amounts received from the market sales are not sufficient to cover the cash required to pay out the investors. As a result, there is a need of borrowing more amounts, thus creating a debt. Because of this risk of allocating more shares than available in the pool of assets, the ledger will not allow “investor 4” to invest the amount of 15000 unless the pool of assets is fed with new shares, where said new shares must be purchased on the market, assuming there are enough cash reserves to purchase further shares.

It is now assumed that the pool of assets is not fed. In this case, because the condition of 25% weighting for each stock has to be met, the “investor 4” will only be able to invest up to 9.084 and to get allocated quantities. This is illustrated in Table 15 below, which shows the number of shares or quantities in the theoretical portfolio are calculated based on the hypothetical stock weightings and stock market prices like in Table 8 and a hypothetical amount invested deviating from Tables 3, 4, 10, 11 and 12, showing the remaining available stocks quantities after deducting the number of shares of the theoretical portfolio of Tables 10, 11 and 12, further showing the number of shares of the theoretical portfolio of the corresponding Table, and showing finally the maximum amount that can be invested, with the assumption that the remaining quantities cannot be negative.

TABLE 15

| | | | | | Number of |
|---|---|---|---|---|---|
| | | | | | shares |
| | | | | | available |
| | | | | Number of | after |
| | | | | shares | investment |
| | Quantity | Stock | | allocated to | from investor |
| | available | weighting | Stock price | investor 4 | 4 |
| Stock A | 3361.44 | 25% | 2 | 1135.5000 | 2225.9445 |
| Stock B | 1550.60 | 25% | 2.5 | 908.4000 | 642.1953 |
| Stock C | 350.86 | 25% | 7 | 324.4285 | 26.4288 |
| Stock D | 1013.89 | 25% | 2.24 | 1013.8392 | 0.0497 |
| Amount | | 9084 | | | |
| invested by | | | | | |
| investor 4 | | | | | |

This implies that there will be still quantities for Stock A and Stock B, that will remain unallocated. However no further client portfolio would be available at this stage as Stock C and Stock D have almost no more shares that can be allocated. In such a case where the number of shares of each stock does not exceed the quantities allocated to all the investors, it can be checked that there will be enough amounts from the stocks sales to disburse the investors if they all decide to disinvest. Specifically, Table 16 below shows the net amount difference between the sum of the quantities like in Tables 9, 10, 11 and 15, multiplied by hypothetical stock market prices and the quantities like in Table 15, multiplied by the same hypothetical stock market prices.

TABLE 16

| | | | | | | Net cash |
|---|---|---|---|---|---|---|
| | | | | | Amount | flow from |
| | | | | | received | sells on the |
| | Amount | | | Amount | from the | market and |
| | allocated to | Amounts | | paid back | company | payments |
| | investors 1, | available in | Stock | to investors | by selling | to investors |
| | 2, 3, 4 | the portfolio | price | 1, 2, 3, 4 | the stocks | 1, 2, 3, 4 |
| Stock A | 14441.06 | 16667.00 | 2 | 28882.1110 | 33334.0000 | 4451.8890 |
| Stock B | 11857.80 | 12500.00 | 2.5 | 29644.5118 | 31250.0000 | 1605.4883 |
| Stock C | 8306.57 | 8333.00 | 7 | 58145.9984 | 58331.0000 | 185.0016 |
| Stock D | 24999.95 | 25000.00 | 2.24 | 55999.8887 | 56000.0000 | 0.1113 |

When only one or few investors partially or totally disinvest their assets and there are sufficient cash reserves, no stock sales are needed on the market to pay those investors. When that occurs, the quantities previously allocated to the investors who are disinvesting are moved back to the pool of assets.

It is now assumed that the previous “investor 2” decides to disinvest all his assets, with the assumption that there are sufficient cash reserves to pay “investor 2”. If “investor 2” disinvests when the stock prices are like previously, Table 17 below shows the net amount paid to the hypothetical investor by multiplying the quantities like in Table 11 by hypothetical stock market prices like in Table 14 showing how the quantities of the defined “pool portfolio” increase summing up the remaining quantities like in Table 15 and the quantities like in Table 11.

TABLE 17

| | Quantity | | | Quantity | |
|---|---|---|---|---|---|
| | available | | | available | |
| | before | | Number of | after | |
| | disin- | | shares | disin- | Amount |
| | vestment | | allocated | vestment | paid to |
| | of | Stock | to | from | investor |
| | investor 2 | price | investor 2 | investor 2 | 2 |
| Stock A | 2225.94 | 2 | 5555.5555 | 7781.5000 | 11111.11 |
| Stock B | 642.20 | 2.5 | 4761.9047 | 5404.1000 | 11904.76 |
| Stock C | 26.43 | 7 | 3571.4285 | 3597.8573 | 25000.00 |
| Stock D | 0.05 | 2.24 | 11111.1111 | 11111.1608 | 24888.89 |

Therefore, “investor 2” receives 72.904 in total and the quantities previously allocated to “investor 2” are moved back to the pool of assets so that the number of shares available for new investors increases. The moment when the investor purchases and how much he invests is of no consequence, he gets allocated quantities of each stock, which value represents 25% of the overall investment, which is also the desired weight of each stock of the hypothetical portfolio (customized quantities allocation).

In the following, a periodical rebalancing can be carried out in order to affect the quantities allocated to each investor differently, without the need for the investors to invest extra amounts.

It is now assumed that “investor 4” has not disinvested yet, with the following stock prices: 1.6 for Stock A, 2.0 for Stock B, 8 for Stock C and 2.8 for Stock D. Further assuming the rebalancing aims to bring the weight of each stock to 25%, stock A and stock B must be purchased to increase their weight, while stock C and stock D have to be sold. Table 18 below shows the value of this theoretical portfolio based on hypothetical prices and quantities like in Table 5, the weight of each stock being calculated by multiplying the quantity by the hypothetical price for each of the four stocks and dividing the result by the sum of the four multiplications.

TABLE 18

| | Quantity | | | Stock | | | |
|---|---|---|---|---|---|---|---|
| | available | | | weighting | Quantities | Quantities | Stock value |
| | in the | Stock | Stock | before | needed for | after | after |
| | portfolio | price | value | rebalancing | rebalancing | rebalancing | rebalancing |
| Stock | 16667.00 | 1.6 | 26667.20 | 14.16% | 12760.00 | 29427.00 | 47083.2000 |
| A | | | | | | | |
| Stock | 12500.00 | 2 | 25000.00 | 13.27% | 11041.00 | 23541.00 | 47082.0000 |
| B | | | | | | | |
| Stock | 8333.00 | 8 | 66664.00 | 35.40% | −2448.00 | 5885.00 | 47080.0000 |
| C | | | | | | | |
| Stock | 25000.00 | 2.8 | 70000.00 | 37.17% | −8185.00 | 16815.00 | 47082.0000 |
| D | | | | | | | |

The total value of the pool portfolio is then 188331.20 while the total value after rebalancing is 188327.20. This is due to rounding, otherwise no relevant change occurs in the portfolio value before and after rebalancing. In all cases, the stock weighting after rebalancing is 25.00%. In the present case, the overall value of the pool of assets does not change, and the rebalancing at investor level follows the same logic with the only difference that the quantities allocated have fractions as in Tables 19, 20, 21 and 22 below, for “investor 1”, “investor 2”, “investor 3” and “investor 4”, respectively. As described hereafter, the value of the portfolio of each investor reflects the quantities allocated to each investor multiplied by the hypothetical prices.

Table 19 below shows the value of the theoretical portfolio based on hypothetical prices and quantities of the theoretical portfolio like in Table 10, the weight of each stock being calculated by multiplying the quantity by the hypothetical price for each of the four stocks and dividing the result by the sum of the four multiplications.

TABLE 19

| | Quantity | | | Stock | | | |
|---|---|---|---|---|---|---|---|
| | allocated | | | weighting | Quantities | Quantities | Stock value |
| | to investor | Stock | Stock | before | needed for | after | after |
| | 1 | price | value | rebalancing | rebalancing | rebalancing | rebalancing |
| Stock | 250.00 | 1.6 | 400.00 | 14.16% | 191.4063 | 441.41 | 706.2501 |
| A | | | | | | | |
| Stock | 187.50 | 2 | 375.00 | 13.27% | 165.6250 | 353.13 | 706.2500 |
| B | | | | | | | |
| Stock | 125.00 | 8 | 1000.00 | 35.40% | −35.7188 | 88.28 | 706.2496 |
| C | | | | | | | |
| Stock | 375.00 | 2.8 | 1050.00 | 37.17% | −122.7679 | 252.23 | 706.2499 |
| D | | | | | | | |

The total value of the portfolio for the investor 1 is then 2825.00 while the stock value after rebalancing is 2825.00. In all cases, the stock weighting after rebalancing is 25.00%.

Table 20 below shows the value of the theoretical portfolio based on hypothetical prices and quantities of the theoretical portfolio like in Table 11, the weight of each stock being calculated by multiplying the quantity by the hypothetical price for each of the four stocks and dividing the result by the sum of the four multiplications.

TABLE 20

| | Quantity | | | Stock | | | |
|---|---|---|---|---|---|---|---|
| | allocated | | | weighting | Quantities | Quantities | Stock value |
| | to investor | Stock | Stock | before | needed for | after | after |
| | 2 | price | value | rebalancing | rebalancing | rebalancing | rebalancing |
| Stock | 5555.59 | 1.6 | 8888.89 | 11.38% | 6646.8253 | 12202.38 | 19523.8093 |
| A | | | | | | | |
| Stock | 4761.90 | 2 | 9523.81 | 12.20% | 5000.0000 | 9761.90 | 19523.8094 |
| B | | | | | | | |
| Stock | 3571.43 | 8 | 28571.43 | 36.59% | −1130.9523 | 2440.48 | 19523.8096 |
| C | | | | | | | |
| Stock | 11111.11 | 2.8 | 31111.11 | 39.84% | −4138.3221 | 6972.79 | 19523.8092 |
| D | | | | | | | |

The total value of the portfolio for the investor 2 is then 78095.24 while the stock value after rebalancing is also 78095.24. In all cases, the stock weighting after rebalancing is 25.00%.

Table 21 below shows the value of the theoretical portfolio based on hypothetical prices and quantities of the theoretical portfolio like in Table 12, the weight of each stock being calculated by multiplying the quantity by the hypothetical price for each of the four stocks and dividing the result by the sum of the four multiplications.

TABLE 21

| | Quantity | | | Stock | | | |
|---|---|---|---|---|---|---|---|
| | allocated | | | weighting | Quantities | Quantities | Stock value |
| | to investor | Stock | Stock | before | needed for | after | after |
| | 3 | price | value | rebalancing | rebalancing | rebalancing | rebalancing |
| Stock | 7500.00 | 1.6 | 12000.00 | 12.86% | 7075.8928 | 14575.89 | 23321.4285 |
| A | | | | | | | |
| Stock | 6000.00 | 2 | 12000.00 | 12.86% | 5660.7142 | 11660.71 | 23321.4284 |
| B | | | | | | | |
| Stock | 4285.71 | 8 | 34285.71 | 36.75% | −1370.5357 | 2915.18 | 23321.4280 |
| C | | | | | | | |
| Stock | 12500.00 | 2.8 | 35000.00 | 37.52% | −4170.9184 | 8329.08 | 23321.4285 |
| D | | | | | | | |

The total value of the portfolio for the investor 3 is then 93285.71 while the stock value after rebalancing is also 93285.71. In all cases, the stock weighting after rebalancing is 25.00%.

Table 22 below shows the value of the theoretical portfolio based on hypothetical prices and quantities of the theoretical portfolio like in Table 15, the weight of each stock being calculated by multiplying the quantity by the hypothetical price for each of the four stocks and dividing the result by the sum of the four multiplications.

TABLE 22

| | Quantity | | | Stock | | | |
|---|---|---|---|---|---|---|---|
| | allocated | | | weighting | Quantities | Quantities | Stock value |
| | to investor | Stock | Stock | before | needed for | after | after |
| | 4 | price | value | rebalancing | rebalancing | rebalancing | rebalancing |
| Stock | 1135.50 | 1.6 | 1816.80 | 20.04% | 281.3403 | 1416.84 | 2266.9445 |
| A | | | | | | | |
| Stock | 908.40 | 2 | 1816.80 | 20.04% | 225.0722 | 1133.47 | 2266.9444 |
| B | | | | | | | |
| Stock | 324.43 | 8 | 2595.43 | 28.62% | −41.0604 | 283.37 | 2266.9448 |
| C | | | | | | | |
| Stock | 1013.84 | 2.8 | 2388.75 | 31.31% | −204.2162 | 809.62 | 2266.9444 |
| D | | | | | | | |

The total value of the portfolio for the investor 4 is then 9067.78 while the stock value after rebalancing is also 9067.78. In all cases, the stock weighting after rebalancing is 25.00%.

The weight of the stocks before rebalancing is different for each investor due to the different prices levels at which the stocks have been allocated to each investor. Consequently, the prices movement from the subscription date differs from investor to investor. After the rebalancing, the weight of each stock is back to the desired 25% for all the four investors. Presently, it is assumed that market conditions and/or economic information and situation may require a change in the initial weighting. In such cases, with the rebalancing the weighting is not necessarily brought back to the original one, the rebalancing of the stocks weighting will be the same for each investor. This allows to align the level of risk across investors of the same portfolio.

All the examples described previously in Tables 3 to 22 represent theoretical and simplified examples with the only purpose to illustrate the embodiments of the present disclosure.

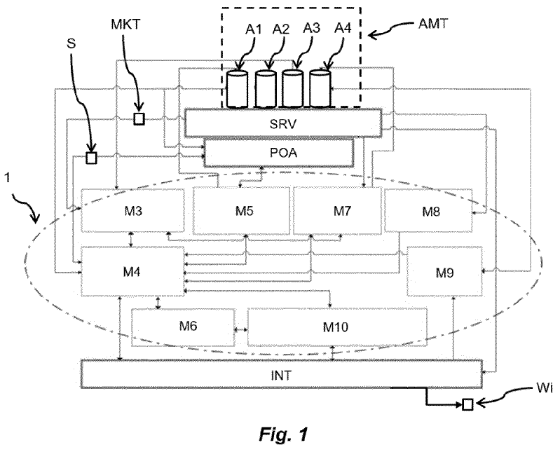

It is now made reference to FIG. 1, which is a schematic view of the components of a system 1 to carry out the method according to the embodiments of the present disclosure. The system 1 is preferably a computer, a smartphone or any other electronic device that can be used for carrying out the method of the present disclosure.

Specifically, the system 1 comprises a plurality of modules with dedicated logic and processes, which are connected to an existing infrastructure, for instance the infrastructure of a Financial Institution, hereafter called FI.

The system 1 allows said infrastructure, e.g., the supporting infrastructure of a FI, to provide their users, or the clients of the FI, with tailored investment portfolios in an intuitive, secure and fast way as well as at a competitive cost.

The infrastructure comprises a database POA, one or more servers SRV as well as a user interface INT.

The database POA is a pool of assets, also called an “Assets Bank”, to which asset management modules A1, A2, A3 and A4 are connected.

In an embodiment, the asset management modules A1, A2, A3 and A4 are asset managers defining an Asset Management Team, called hereafter AMT. In a possible embodiment, each of the asset management module can be replaced by a human user, called asset manager.

The pool of assets defines an initial pool comprising securities, bonds, derivatives and or cash reserves. Said pool of assets allows feeding one or more client portfolios.

The AMT is adapted for actively managing the POA and is responsible for managing the inventory of the POA. The POA is connected to a Reconciliation & Exception Management Module M5 of the system 1, described here after, said connection enabling informing one or more of the asset management modules A1, A2, A3 and A4 about inventory maintenance needs. As illustrated, the Reconciliation & Exception Management Module M5 is connected to the asset manager A1 and to the POA.

As an example, a notification can be sent from M5 to A1, A2, A3 and/or A4 if there is too few of a quantity of a given asset in the pool to meet specific buying orders. Respectively, a notification can be sent from M5 to A1, A2, A3 and/or A4 if there is not enough cash within the pool to cover disbursement orders.

In any case, once one or more assets have been purchased on a market, the assets in the pool POA are held in a deposit account within the FI.

The one or more servers SRV comprise market data. Market data includes asset prices, exchange rates, corporate actions, dividends, coupons etc. The components of market data are made available by the FI via a daily interface to the system 1. Preferably, the FI has an interface with one or more financial providers. If not, the system 1 can be connected to said financial provider(s) through a dedicated interface.

The one or more servers SRV comprising the market data is important since market data are required to define the parameterization of the portfolios within the Portfolio Parameterization Module M3 of the system 1. As described hereafter, the Portfolio Parameterization Module M3 is connected to at least one asset manager, here A3, and to the POA.

Further, market data are required to feed the Key parameter Monitoring & Rebalancing module M7 of the system 1 with updated asset prices and other market data needed by the module to monitor defined risk and performance thresholds. If such thresholds are attained, the Key parameter Monitoring & Rebalancing module M7 is configured to trigger the recalculation of the portfolio weighting, namely a rebalancing of said portfolio. As described hereafter, the Key parameter Monitoring & Rebalancing module M7 is connected to at least one asset manager, here A4, to the Portfolio Parameterization Module M3 and to the server(s) SRV comprising market data.

In addition, market data are required to feed the user interface INT. Said user interface INT comprises consumer channel user interfaces so that the clients of the FI can see the prices of the securities on their portfolio(s), and the evolution of the same.

The user interface INT defines a consumer channel, with a user interface to a website of the FI or to an app of the FI. Such a component can be part of the FI infrastructure itself and can be configured to distribute a computer software comprising instructions to carry out the method described in the present disclosure.

Specifically, said computed software can be distributed to an end user. Via the user interface INT, said user can access bought portfolios which have been tailored according to the method described in the present disclosure, see their evolutions, choose to redeem said portfolio at a given time, participate to a reward program, receive communications from the corresponding FI and/or perform actions such as contacting a help desk, such actions being for instance part of customer care process or services provided by the FI.

As illustrated, the system 1 comprises a plurality of modules M3, M4, M5, M6, M7, M8, M9 and M10.

The module M3 is a Portfolio Parameterization module, that is, a module configured for parametrizing a portfolio.

The module M3 is required to define which asset is part of a specific portfolio, its risk level and the weighting of each asset within the portfolio. Preferably, the design of each portfolio, namely its thematic, sectorial and/or geographical type, is selected by one of the asset management modules, which is then called “Portfolio Designer”.

The module M3 further comprises raw market data and calculated data. Said data comprises key parameters such as one or more lists of securities and derivatives adapted to be part of the portfolio, one or more weightings of securities according to the portfolio design or to market capitalization, one or more volatilities of the securities, one or more correlation between the securities and one or more overall risk limits of the portfolio.

The module M3 is configured so as to provide the module M7 described hereafter with the volatility, correlation, market capitalization of each security, as well as the overall risk limit for a given portfolio. This enables the module M7 to carry out an automated rebalancing of the portfolio.

Respectively, if a rebalancing takes place, the module M7 is configured to update the securities weighting requirement within the module M3. The module M3 is further configured to save and store the history of the weighting configuration.

In addition, the module M3 is configured to initiate the automated rebalancing of the client portfolio. The module M4 is configured to collect, i.e. consume the latest stored weighting configuration provided by the module M3 and to compute the rebalancing transactions which will impact the client portfolio as provided to the module M10 described hereafter.

In an embodiment, the composition of a given portfolio can be changed at any time based on the market analysis made by the AMT. In that scenario, new portfolio compositions with related weighting can be transmitted to the module M4 described hereafter.

The module M4 is a Transactions Management Module that is, a module configured for managing transactions.

Specifically, the module M4 is configured for determining required internal transactions to be posted at the level of an individual client portfolio, and further transmit this information passed to the module M10 described hereafter.

The module M4 is configured to provide an interface between the consumer channel INT and the system 1.

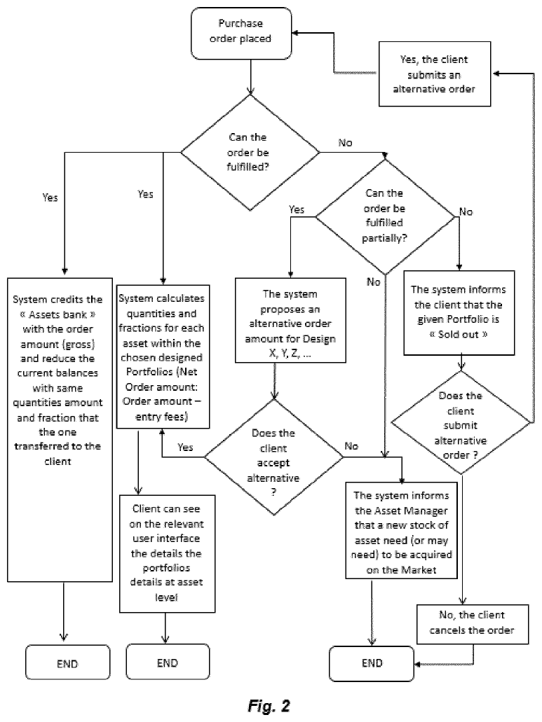

The module M4 is further configured to carry out the purchase process illustrated in FIG. 2.

As illustrated in FIG. 2, the module M4 relies on elements including portfolio choices of the user, the order amount provided by INT and one or more configuration elements of the given portfolio such as a key parameter of the portfolio transmitted by the module M3 at the same moment as that the order.

When carrying out the purchase process, the module M4 provides these elements to the module M5 described hereafter to determine whether the order can be fulfilled. In case of success, the module M4 provides these elements to the module M6 described hereafter which provides back the relevant fee rate based on a configured fee matrix.

The module M4 is further configured to then determine the transactions to be posted at the level of the client portfolio level and/or at the level of the POA.

Specifically, at the client portfolio level, the module M4 calculates the net order amount and the quantities of each underlying asset belonging to the purchased portfolio. The module M4 then provides the details of the order to the module M10 described hereafter, which stores the order static data.

Herein, the term “order static data” refers to client identification details, which can be shared by INT, identification data of the purchased portfolio, purchase order amount data, data of purchase net amount used for securities quantities calculation, entry fees details, securities quantity for each position of the chosen portfolio and security prices applied at the purchase date, e.g., securities quantities for each for the bought portfolio.

Stored order static data can then be used by the consumer channel of INT along with updated market data from the server(s) SRV, allowing the client to access the details of one or more assets he/she is entitled to, as well as the details of the evolution of his/her portfolio in real-time.

Specifically, at the level of the POA, the module M4 credits the “Assets bank” with the cash amount paid by the client and reduces the current balance of each asset (part of the purchased portfolio) with the same quantities amount that have been transferred to the client. This allows to avoid any transaction to take place directly on the market, so that the source of the assets quantities transferred to the client in the tailored portfolio is provided to the “Assets bank.”

If an exception is identified by the module M5 as per indicated in FIG. 2, the latter may either inform the client that the given portfolio is “sold out” or propose an alternative order amount. Indeed, the availability of a portfolio depends on the quantities held at the “Asset Bank” level, or POA. The module M5 can also reports all exceptions to the AMT, e.g., through the generation of an e-mail, which, in turn, can take appropriate actions at the “Asset Bank” level.

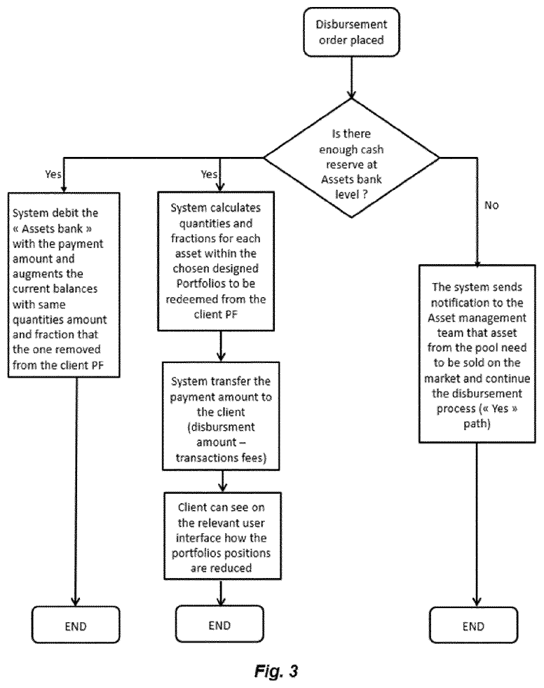

The module M4 is further configured to carry out the disbursement process illustrated in FIG. 3.

As illustrated, the disbursement process carried out by the module M4 relies on portfolio choices as well as disbursement options provided by INT, the consumer channel. The module M4 then passes the details to the module M5 to determine whether the order can be fulfilled.

In case of success, so if the order can be fulfilled, the module M4 passes the disbursement details to the module M6, which is a fee management module and which is configured to provide back the relevant fee rate based on a configured fee matrix. Then, the Module 4 determines the transactions to be posted at the client portfolio level and at the “Assets Bank” level, as described hereafter.

At the client portfolio level, the module M4 determines the net disbursement amount, which is transferred to the client cash account. The module M4 further calculates for each security of the redeemed portfolio the redeemed quantities. Then it provides the full order details back to the module M10, which is configured to store disbursement static data.

Herein, the term “disbursement static data” may comprise the identification details of a client, identification data of the redeemed portfolio, a chosen disbursement option, a calculated gross amount of a redemption order, a redemption order net amount used for securities quantities calculation in case of partial disbursement, exit fees details, securities quantity for one or more positions of the chosen portfolio, and security prices applied at the redemption date which correspond to securities quantities for each for the redeemed portfolio.

Disbursement static data is used by INT and the corresponding consumer channels along with updated market data from the server(s) SRV. This enables a user or a client to be informed, in case of partial redemption, of the remaining quantities at asset level he/she is entitled to, and the evolution of his/her portfolio in real-time.

At the POA or “Asset Bank” level, the same process as the process used for the purchase transactions is carried out but in the other direction. During the purchase transactions, the seller was the POA, or “Asset bank”. Correspondingly, during the disbursement process, the buyer is the “Asset Banks”. Hence, the module M4 credits the “Asset bank” with the quantities amount redeemed by the client, debits the “Assets Bank” with corresponding cash equivalent and transfers the relevant transaction fees to the respective client cash account.

In case of an exception identified by the module M5, for instance if there is not enough cash reserve in the pool to fulfil the redemption, an e-mail notification is sent to at least one of the asset managers of AMT, so that appropriate actions can be taken. An example of such an action is the sale of an asset from the pool to increase the cash position of the pool. Advantageously, this process is fully transparent for the user or client, and the disbursement order is processed as long as there is no exception.

In addition, the Transactions Management module M4 can be further configured so that M4 manages system generated transactions as part of a portfolio composition update of the module M3, so that M4 manages system generated transactions as part of the collection of management & performance fess provided by the module M6, so that M4 manages system generated transactions as part of the rebalancing process carried out by the module M7, so that M4 manages system generated transactions as part of the corporate action process carried out by module M8, and/or so that M4 manages ad hoc internal transaction requested by an asset manager among AMT as part of a reward management process carried out by module M9.

This allows the Transactions Management module M4 to determine how the client portfolio positions and the “Asset bank” positions need to be updated before passing the relevant details to module M10, so that it is reflected at the consumer user interface level in INT and/or at the Assets Bank level in POA. This enables an improved monitoring of the management team when such a management team is included in the process.

The module M5 is a Reconciliation & Exception Management Module, which is configured to ensure the integrity of the pool. Herein, the pool provides optimal conditions to the user, such as a client, and a response time as short as possible for the purchase and disbursement processes.

The module M5 is further configured to ensure that aggregated positions of the portfolios of the user is not higher than the overall position held at the “Asset Bank” level. Respectively, only cash reserves available in the POA, or the “Asset Bank”, can be used for disbursements.

Specifically, the module M5 is configured to implement validation rules. Said validation rules are such that the module M5 checks if there are enough assets to cover buying orders, or enough cash to cover disbursement orders.

For instance, if a buying order cannot be fulfilled, the module M5 may propose to the module M4 an alternative order amount based on the assets available in the POA.

Accordingly, the module M5 may trigger exception management processes.

For instance, the module M5 is configured to notify the AMT, via a system generated e-mail, that no more assets are available in the POA. If the cash reserve is insufficient, the module M5 may calculate how many securities are needed to be sold to cover the disbursement order(s), the module M5 being further configured in that case to provide the corresponding details in the e-mail notification.

The module M6 is a Fee management module, which is configured to store a plurality of fee matrices. Such matrices comprise fees such as entry fees, exit fees, management fees and performance fees.

The module M6 is configured to be called by the Transactions Management Module M4 during the purchase process for determining the entry fees. This allows encouraging diversification, as well as tiered fees schedule. For instance, if the user or the client invests in more than one portfolio (offering), the entries fees can be made to decrease.

The module M6 is further configured to be called by the Transactions Management Module M4 during the disbursement process for determining the exit fees. This enables providing the user or the client with long term growth of his assets. It is also possible to plan high exit fees to prevent speculative usage if the user tries to exit prior to a given period.

The module M6 can be further configured so that, during a portfolio retention period, on a regular basis such as a yearly basis, and based on the management and performance fee schedule as well as on data provided by the module M10, the module M6 can either calculate due fees and provide corresponding instruction details to the module M4 for further processing or collect fees if the client disburse before the end of the year, said collected fees being based at the prorate during the disbursement process.

The module M7 is a key parameter monitoring and rebalancing module, that is a module configured for monitoring and rebalancing the key parameters.

Specifically, the module M7 is configured to reevaluate on a regular basis, such as a daily basis, that the current portfolio weighting stored in the portfolio parametrization module M3 is still in line with the key parameters determined by the AMT. Indeed, the weighting of the assets within the portfolio is/are determined by the evolution of volatility, correlation and the market capitalization of the underlying asset(s).

In order to carry out such a reevaluation, the module M7 relies on daily “Market data” and/or feed provided by SRV, as well as any list of assets that can be provided by the module M3 for the corresponding portfolio.

The module M7 is further configured so that if thresholds are hit, it notifies the AMT via system generated e-mail that a new weighting is available. If said weighting is successfully reviewed and approved, the module M7 can overwrite the latest weighting. The new weightings details can then be passed to the module M4 in view of calculating, for each user or client portfolio, the rebalancing transactions required. Said rebalancing transactions can then be posted at the client portfolio management module M10, which enables the change to be reflected at the level of INT.

The module M8 is a corporate action management module. The module M8 is configured so that, based on the data provided by SRV, it determines how many dividends or coupons can be entitled to each client portfolio, based on data being preferably market data feed and asset position details of each client portfolio stored in the module M10. System generated transactions can then be passed to the transactions management module M4 which determines the asset quantities equivalent to be applied or reflected at the client portfolio level, i.e. at the level of module M10.

The module M9 is a reward management module.

The purpose of the module M9 is to reward the user, i.e. a portfolio holder, who has a marketable suggestion of a portfolio or a suggestion for improving the service via INT. The user can also send such suggestion for review by the AMT, the reward modalities being captured in the module M9, which then passes the instruction details to the module M4 for determining the asset quantities equivalent to be applied or reflected at the portfolio level in the module M10. This can be carried out in case of a free portfolio increase or in case of a cash incentive the module M10 handles during a payment process, for instance on the client personal cash account.

The module M10 is a client portfolio management module and defines the central register of the client portfolio.

The purpose of this module M10 is to store the details and/or the history of each transaction which can impact the client portfolio, as being stored on the module M4 and provided by the module M4.

Herein, said transaction can be a purchase order or a disbursement order. The transaction can be due to an update of the portfolio composition by the module M3, due to a fee collection by the module M6, due to a rebalancing by the module M7, or due to actions carried out by the module M8, such as corporate actions. The transaction can also be an ad hoc transaction via the reward process as carried out by the module M9.

In any case, the module M10 is configured to feed INT with any update of the portfolio composition, especially an update of quantities or a communication from the FI pertaining to the details of the portfolio. For each transaction, corresponding system client notifications can be generated and provided to the user, for instance pushed at an user interface level.

1. Method for determining a weighting of a diversified security portfolio, wherein the method comprises:
a) receiving, by a first module, a security from an asset database, said first module being called portfolio parameterization module,
b) upon receipt of the security, configuring, by the first module, said diversified security portfolio based on predetermined parameters, said predetermined parameters being transmitted by at least one asset management module to the first module,
c) determining, by a second module, the weighting of the configured diversified security portfolio, said determining being based on current market data parameters provided by one or more servers, said current market data parameters comprising market capitalization of the security, volatility of the security and correlation between securities, said second module being called key parameter monitoring and rebalancing module, and
d) transmitting, by a third module, the determined weighting to a user interface, said third module being called transactions management module.

2. Method according to claim 1, wherein the configuring comprises transferring a number of shares of said security from the asset database to the first module or transferring a number of shares of said security from the first module to the asset database for modifying a percentage of the security present in the diversified security portfolio.

3. Method according to claim 1, wherein the method further comprises e) storing, by a fourth module, a plurality of fee matrices, said fee matrices comprising at least one fee among an entry fee, an exit fee, a management fee and a performance fee of the security, the fourth module being further configured for determining transaction instructions of the security to be carried out, said fourth module being called fee management module.

4. Method according to claim 1, wherein the method further comprises f) storing, by a fifth module, static data provided by the third module and/or for receiving transaction instructions provided by the fourth module, said fifth module being called client portfolio management module.

5. Method according to claim 1, wherein the method further comprises g) computing, by a sixth module, a dividend, a coupon, an asset price and/or an exchange rate of the security of the diversified security portfolio, the computing being based on the current market data parameters and on the determined weighting, said sixth module being called corporate action management module.

6. Method according to claim 1, wherein the receiving, the configuring, the determining and the transmitting are carried out iteratively for the security as long as the value of the weighting is smaller than a predetermined level.

7. Method according to claim 1, wherein the method further comprises h) validating, by a seventh module, the transferring of a number of shares of the security from the asset database to the first module, the transferring a number of shares of said security from the first module to the asset database or a transaction instruction of the security to be carried out, said seventh module being called reconciliation and exception management module.

8. Method according to claim 1, wherein the method further comprises i) providing the user interface, by an eighth module, with a notification message, said notification message comprising at least one of an information of the diversified security portfolio, a transaction suggestion of the security in the diversified security portfolio and a service improvement suggestion, said eighth module being called reward management module.

9. System for determining a weighting of a diversified security portfolio, wherein the system comprises:
a first module, called portfolio parameterization module, configured for receiving a security from an asset database and configuring, upon receipt of the security, said diversified security portfolio based on predetermined parameters, said predetermined parameters being transmitted by at least one asset management module to the first module,
a second module, called key parameter monitoring and rebalancing module, configured for determining the weighting of the configured diversified security portfolio based on current market data parameters provided by one or more servers, said current market data parameters comprising market capitalization of the security, volatility of the security and correlation between securities, and
a third module, called transactions management module, configured for transmitting the determined weighting to a user interface.

10. System according to claim 9, further comprising a fourth module, called fee management module, configured for storing a plurality of fee matrices, said fee matrices comprising at least one fee among an entry fee, an exit fee, a management fee and a performance fee of the security, the fourth module being further configured for determining transaction instructions of the security to be carried out.

11. System according to claim 10, further comprising a fifth module, called client portfolio management module, configured for storing static data provided by the third module and/or for receiving transaction instructions provided by the fourth module.

12. System according to claim 11, further comprising a sixth module, called corporate action management module, configured for computing a dividend, a coupon, an asset price and/or an exchange rate of the security of the diversified security portfolio, the computing being based on the current market data parameters and on the determined weighting.

13. Computer software comprising instructions to implement at least a part of a method according to claim 1, when the software is executed by a processor.

14. Computer-readable non-transient recording medium on which a software is registered to implement a method according to claim 1, when the software is executed by a processor.
